(19) United States
(12) Patent Application Publication
(10) Pub. No.: US 2026/0360093 A1
(43) Pub. Date: Nov. 12, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Motoji KAWAI, Tokyo (JP); Kentarou SASAGAWA, Tokyo (JP)

(73) Assignee: NEC Corporation, Tokyo (JP)

(21) Appl. No.: 19/653,385

(22) Filed: Apr. 21, 2026

(30) Foreign Application Priority Data
May 8, 2025 (JP) 2025-078014

(51) Int. Cl. G06T 19/00; G06T 19/20

(52) U.S. Cl. CPC G06T 19/006; G06T 19/20; G06T 2219/2004

(57) ABSTRACT

An information processing device according to the present disclosure includes a first acquisition unit, a second acquisition unit, a display control unit, and a reception unit. The first acquisition unit acquires a real image generated by imaging a real space. The second acquisition unit acquires a virtual image generated by imaging a virtual space that reproduces the real space. The display control unit displays the real image and the virtual image on an operation screen. The reception unit receives a predetermined instruction, by an operation on both of the real image and the virtual image displayed on the operation screen.

This application is based upon and claims the benefit of priority from Japanese patent application No. 2025-78014, filed on May 8, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

WO 2024/147194 A1 discloses the related art. WO 2024/147194 A1 discloses a technique for reproducing and displaying an object existing in a real world in a virtual space.

### SUMMARY

An example of an object of the present disclosure is to develop a technology regarding a user interface.

According to one aspect of an example of the present disclosure,
an information processing device is provided that includes
first acquisition means for acquiring a real image generated by imaging a real space,
second acquisition means for acquiring a virtual image generated by imaging a virtual space that reproduces the real space,
display control means for displaying the real image and the virtual image on an operation screen, and
reception means for receiving a predetermined instruction, by an operation on both of the real image and the virtual image displayed on the operation screen.

According to one aspect of an example of the present disclosure,
an information processing method performed by one or more computers is provided that includes
acquiring a real image generated by imaging a real space,
acquiring a virtual image generated by imaging a virtual space that reproduces the real space,
displaying the real image and the virtual image on an operation screen, and
receiving a predetermined instruction, by an operation on both of the real image and the virtual image displayed on the operation screen.

According to one aspect of an example of the present disclosure,
a program is provided that causes a computer to function as
first acquisition means for acquiring a real image generated by imaging a real space,
second acquisition means for acquiring a virtual image generated by imaging a virtual space that reproduces the real space,
display control means for displaying the real image and the virtual image on an operation screen, and
reception means for receiving a predetermined instruction, by an operation on both of the real image and the virtual image displayed on the operation screen.

According to an example of the present disclosure, it is possible to develop a technology regarding a user interface.

### BRIEF DESCRIPTION OF THE DRAWINGS

FIG. 1 is a diagram illustrating an example of a functional block diagram of an information processing device;

FIG. 2 is a flowchart illustrating an example of a flow of processing of the information processing device;

FIG. 3 is a diagram illustrating an example of a device that cooperates with the information processing device;

FIGS. 4A and 4B are diagrams illustrating examples of a use scene of the information processing device;

FIG. 5 is a diagram illustrating an example of an operation screen provided by the information processing device;

FIG. 6 is a diagram illustrating an example of a hardware configuration of the information processing device;

FIG. 7 is a diagram illustrating another example of the functional block diagram of the information processing device;

FIG. 8 is a diagram illustrating another example of the operation screen provided by the information processing device;

FIG. 9 is a flowchart illustrating another example of the flow of the processing of the information processing device;

FIG. 10 is a diagram illustrating still another example of the operation screen provided by the information processing device;

FIG. 11 is a flowchart illustrating still another example of the flow of the processing of the information processing device; and

FIG. 12 is a flowchart illustrating yet another example of the flow of the processing of the information processing device.

### EXAMPLE EMBODIMENT

Hereinafter, an example embodiment of the present disclosure will be described with reference to the drawings. In this disclosure, the drawings are associated with one or more example embodiments. In all the drawings, similar components are denoted by similar reference signs, and descriptions thereof will be omitted as appropriate.

### First Example Embodiment

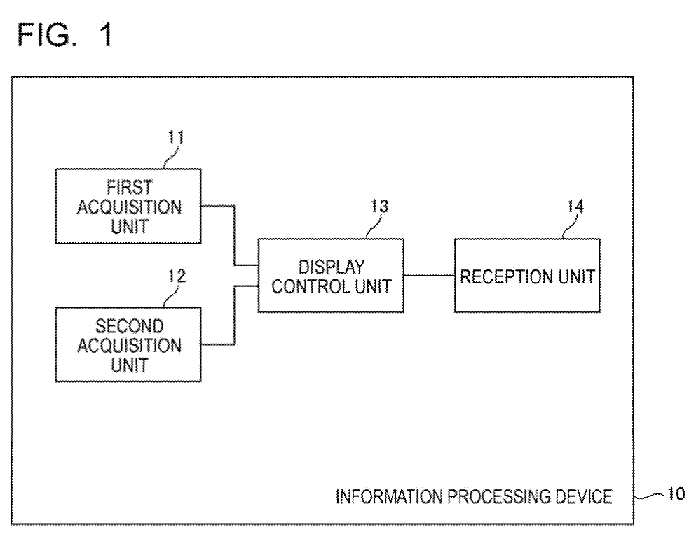

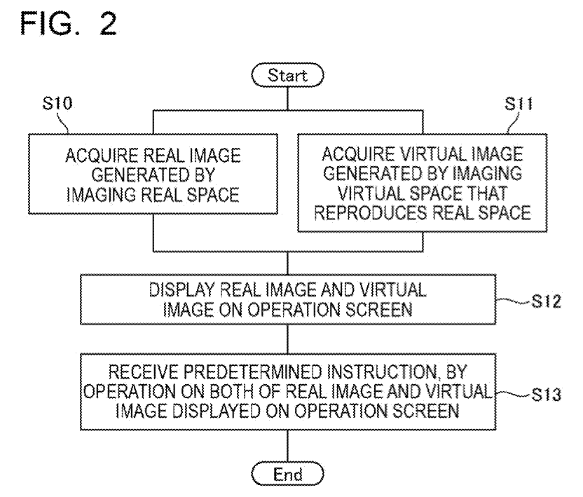

FIG. 1 is a functional block diagram illustrating an outline of an information processing device 10. FIG. 2 is a flowchart illustrating an example of a flow of processing executed by the information processing device 10.

As illustrated in FIG. 1, the information processing device 10 includes a first acquisition unit 11, a second acquisition unit 12, a display control unit 13, and a reception unit 14. The processing illustrated in the flowchart in FIG. 2 is executed by these functional units.

In S10, the first acquisition unit 11 acquires a real image generated by imaging a real space.

In S11, the second acquisition unit 12 acquires a virtual image generated by imaging a virtual space that reproduces the real space.

In S12, the display control unit 13 displays the real image acquired in S10 and the virtual image acquired in S11 on an operation screen.

In S13, the reception unit 14 receives a predetermined instruction, by an operation on both of the real image and the virtual image displayed on the operation screen.

A processing order of S10 and S11 is not limited to the illustrated example. S10 and S11 may be performed in parallel, S11 may be performed after S10, or S10 may be performed after S11.

Meanwhile, there is a user interface that displays a real image generated by imaging a real space and receives a predetermined instruction by an operation on the real image. For example, for a user interface for operating a machine, a robot, a moving body, or the like, such a user interface using the real image is used.

The user interface using the real image receives, for example, an operation for designating a certain position in the real image from a user. By this operation, for example, an object displayed at the designated position in the real image is designated as an object to be processed. By this operation, for example, a position in the real space displayed at the designated position in the real image is designated as a position to be processed.

Then, some of the user interfaces using the real image receive the predetermined instruction by the plurality of operations on the plurality of real images from the user. For example, a user interface or the like is considered that receives an instruction for designating the object to be processed by an operation on a real image, designating a position where the object is placed by an operation on another real image obtained by imaging another position, and moving the designated object to the designated position. In addition, a user interface or the like is considered that receives an instruction for designating the plurality of objects to be processed by the operation on each of the plurality of real images obtained by imaging positions different from each other and positioning the plurality of designated objects close to each other. The user interface that receives the predetermined instruction by the plurality of operations on the plurality of real images is not limited to these examples.

In a case of the user interface that receives the predetermined instruction by the plurality of operations on the plurality of real images, a plurality of cameras for imaging the plurality of real images is required. As a result, a cost burden increases. A work load required for installation of a camera, maintenance of a camera, or the like increases.

The information processing device 10 according to this example embodiment has a configuration capable of solving the above problem. As described above, the information processing device 10 acquires the real image generated by imaging the real space and the virtual image generated by imaging the virtual space that reproduces the real space. Then, the information processing device 10 displays the acquired real image and virtual image on the operation screen and receives the predetermined instruction by the operation on both of the real image and the virtual image displayed on the operation screen.

According to such an information processing device 10, the user interface as described above can use the virtual image instead of the real image. In this case, the number of cameras that image the real space can be reduced. As a result, a cost burden for preparing the plurality of cameras and the work load required for the installation of the camera, the maintenance of the camera, or the like can be reduced.

The information processing device 10 can use not only the virtual image but also both of the real image and the virtual image, in the user interface as described above. Although the real space is reproduced in the virtual space, there is a user need to perform a specific operation while viewing the real image, instead of the virtual image. According to the information processing device 10 capable of using both of the real image and the virtual image, an appropriate one of the real image and the virtual image can be used, depending on content of the operation. As a result, it is possible to achieve the user interface that satisfies the user need as described above, while reducing the number of cameras that image the real world.

In this way, according to the information processing device 10 according to the example embodiment, a technology regarding the user interface can be developed.

### Second Example Embodiment

### Outline

An information processing device 10 according to a second example embodiment is obtained by embodying the configuration of the information processing device 10 according to the first example embodiment. Hereinafter, details will be described.

### Overview

In this example embodiment, the user interface of the information processing device 10 described in the first example embodiment is used in a scene where a mobile device that moves a baggage is operated. A use scene of the information processing device 10 is not limited to the example of the example embodiment.

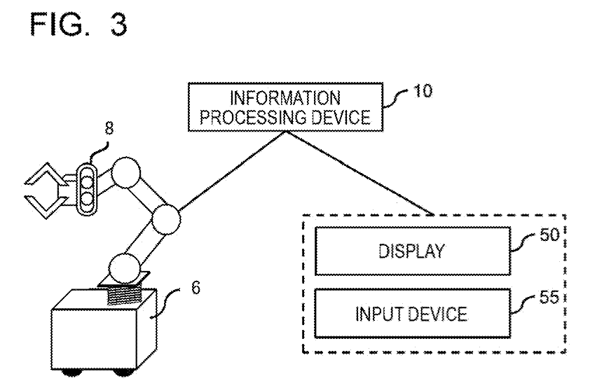

As illustrated in FIG. 3, the information processing device 10 is used together with a mobile device 6, a display 50, and an input device 55. The display 50 and the input device 55 may be physically and/or logically integrated with the information processing device 10 or may be physically and/or logically separated from the information processing device 10.

The mobile device 6 is used in various places. For example, the mobile device 6 may be used in at least one of a factory, a warehouse, and a distribution base. The mobile device 6 has a mechanism for moving an object. The mobile device 6 may be self-propelled. The mobile device 6 is, for example, a handler robot. The mobile device 6 includes, for example, an arm. The arm can have six degrees of freedom. Specifically, the arm can have a freedom of movement in an X-axis direction, a freedom of movement in a Y-axis direction, a freedom of movement in a Z-axis direction, a freedom of rotation around the X-axis, a freedom of rotation around the Y-axis, and a freedom of rotation around the Z-axis. At a front end of the arm, a gripping mechanism (end effector) for gripping an object is provided. Configurations of the arm and the gripping mechanism of such a mobile device 6 can be achieved by using a widely known technique.

A camera is installed in the mobile device 6. Hereinafter, the camera installed in the mobile device 6 is referred to as a “mobile device camera 8”. For example, the mobile device camera 8 is installed near the front end of the arm. The mobile device camera 8 generates an image by imaging a real space. Hereinafter, the image generated by imaging the real space is referred to as a “real image”. The mobile device camera 8 can image a moving image (real image). A frame rate is, for example, equal to or more than 2 frames/second, preferably equal to or more than 10 frames/second, but not limited to these. The mobile device camera 8 can detect and image visible light.

The mobile device camera 8 may have a function for generating depth information of the object in the real image. The depth information indicates a distance from the mobile device camera 8 to the object. The depth information is generated using a widely known technique. The mobile device camera 8 may generate the depth information, for example, using a laser, a stereo camera, or the like.

The mobile device camera 8 may include an inclination sensor. By using sensing information by the inclination sensor, a rotation angle of the real image with reference to a horizontal plane can be specified.

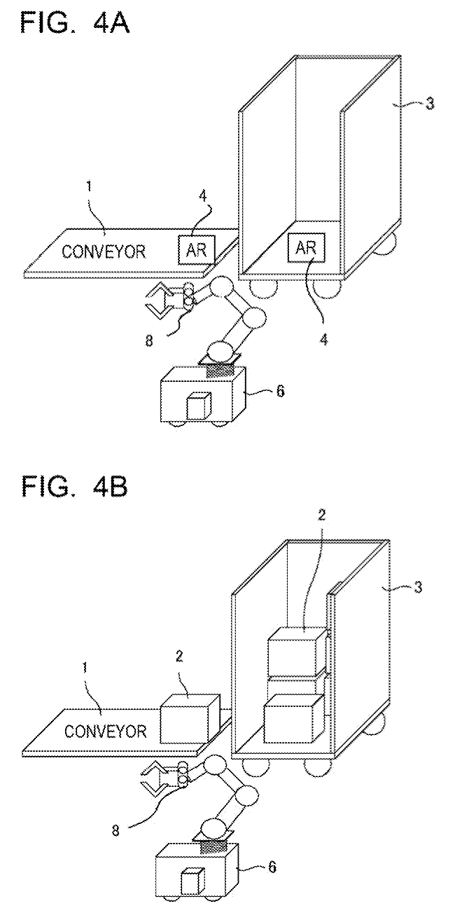

The mobile device 6 moves an object positioned in a first region to a second region, in accordance with an instruction from the user. There are various combinations of the first region and the second region. For example, each of the first region and the second region is a shelf, a conveyor, a vehicle, a carriage, a cart, a transport container, an object storage area, or the like. The first region and the second region may be the same type or different types. In this example embodiment, as illustrated in FIGS. 4A and 4B, the mobile device 6 moves a package 2 on a conveyor 1 into a cart 3. Specifically, the mobile device 6 moves an object (package 2) designated by the user to a position (designated position in cart 3) designated by the user.

The display 50 and the input device 55 are used by the user, for example. The information processing device 10 displays a user interface (UI) screen on the display 50 and receives an operation from the user via the UI screen. The display 50 and the input device 55 may be physically and/or logically integrated with each other or may be physically and/or logically separated from each other. An example in which the display 50 and the input device 55 are physically and/or logically integrated is, for example, a touch panel display or the like.

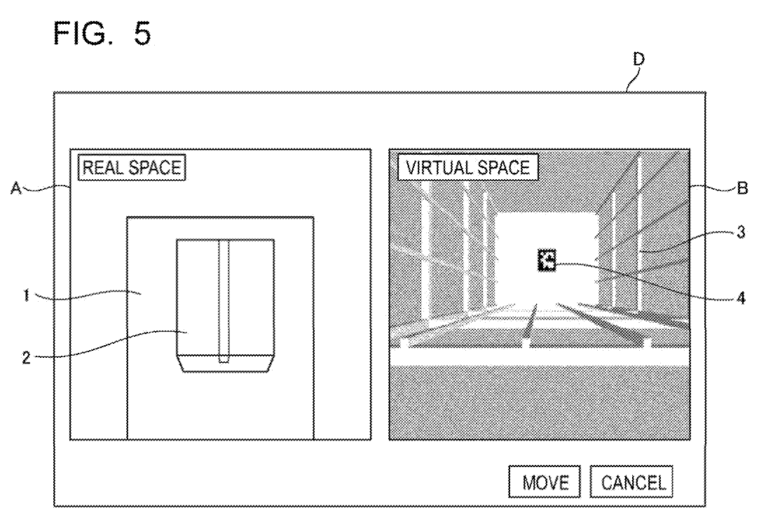

FIG. 5 illustrates an example of the UI screen. The illustrated UI screen displays the real image generated by imaging the real space, in a first area A. The UI screen displays a virtual image generated by imaging a virtual space that reproduces the real space, in a second area B.

The real image displayed in the first area A is an image generated by imaging a real world by the mobile device camera 8 attached to the mobile device 6. In FIG. 5, a real image obtained by imaging the package 2 on the conveyor 1 is displayed.

The virtual image displayed in the second area B is an image generated by imaging the virtual space by a virtual camera. In FIG. 5, a virtual image obtained by imaging the cart 3 in the virtual space is displayed. The virtual image in FIG. 5 is an image obtained by imaging a floor of the cart 3 from an upper side of the cart 3 to a lower side of the cart 3. In the example in FIG. 5, a marker 4 attached to the floor of the cart 3 is imaged.

For example, the user designates the package 2 as an object to be processed, by an operation for designating an area where the package 2 is displayed, in the real image displayed in the first area A. The user designates a position where the package 2 is loaded, by an operation for designating a desired position (desired position in cart 3) in the virtual image displayed in the second area B. These operations can be achieved by using widely known techniques such as drag and drop, click, or tap. Then, after performing these operations, the user issues an instruction to load the designated package 2 at the designated position. The information processing device 10 inputs the instruction received via the UI screen to a control device of the mobile device 6. Then, the mobile device 6 moves the designated package 2 to the designated position, in accordance with the instruction.

Hereinafter, a configuration of such an information processing device 10 will be described in detail.

### Hardware Configuration

First, an example of a hardware configuration of the information processing device 10 will be described. Each functional unit of the information processing device 10 is achieved by any combination of hardware and software. It is to be understood by those skilled in the art that there are various modified examples of a method and device for achieving the functional units. The software includes a program stored in advance from a stage of shipping the device, a program downloaded from a recording medium such as a compact disc (CD), a server on the Internet, or the like.

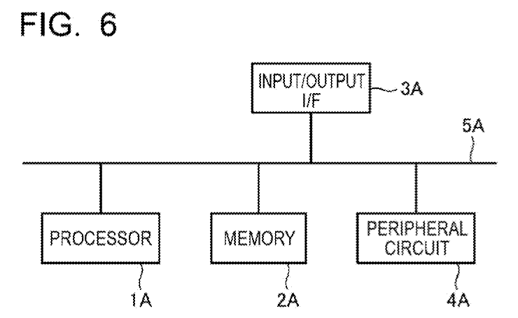

FIG. 6 is a block diagram illustrating a hardware configuration of the information processing device 10. As illustrated in FIG. 6, the information processing device 10 includes a processor 1A, a memory 2A, an input/output interface 3A, a peripheral circuit 4A, and a bus 5A. The peripheral circuit 4A includes various modules. The information processing device 10 does not necessarily include the peripheral circuit 4A. The information processing device 10 may include a plurality of physically and/or logically separated devices. In this case, each of the plurality of devices may have the hardware configuration described above.

The bus 5A is a data transmission path through which the processor 1A, the memory 2A, the peripheral circuit 4A, and the input/output interface 3A mutually transmit and receive data. The processor 1A is, for example, an arithmetic processing device such as a central processing unit (CPU) or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like, an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a projection device, a speaker, a printer, a mailer, or the like. The processor 1A may issue a command to each of the modules and perform calculation based on calculation results of the modules.

### Functional Configuration

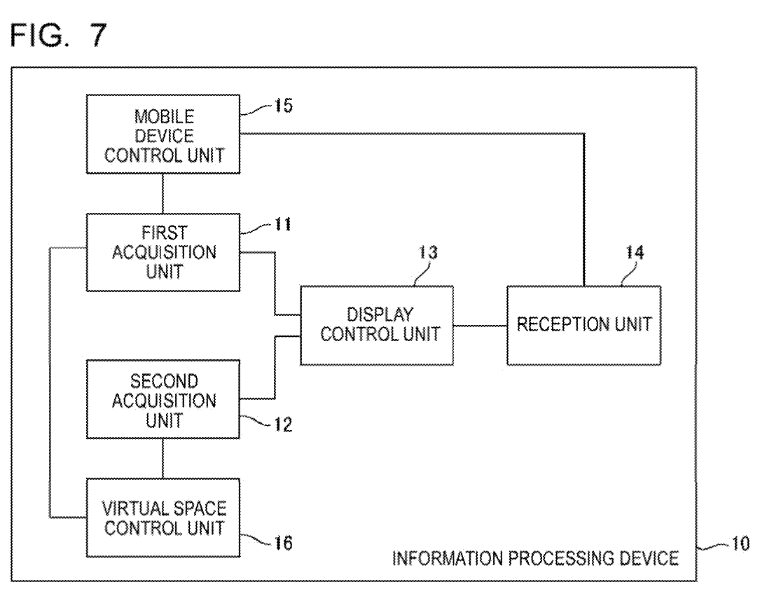

Next, a functional configuration of the information processing device 10 will be described in detail. FIG. 7 is an example of a functional block diagram of the information processing device 10. As illustrated, the information processing device 10 includes a first acquisition unit 11, a second acquisition unit 12, a display control unit 13, a reception unit 14, a mobile device control unit 15, and a virtual space control unit 16.

The mobile device control unit 15 controls an operation of the mobile device 6. The mobile device control unit 15 may be provided in the information processing device 10 or may be provided in an external device that is communicable with the information processing device 10.

The mobile device control unit 15 can execute object moving processing for moving the object designated by the user to the position designated by the user, by controlling the mobile device 6. Details of this processing will be described later.

The mobile device control unit 15 can execute calibration before the object moving processing. In the calibration, the mobile device control unit 15 inputs a control signal to the mobile device 6 and causes the mobile device 6 to execute a calibration operation. The mobile device 6 executes a predetermined calibration operation and images surroundings using the mobile device camera 8. For example, the mobile device 6 rotates the arm by 360° and images a surrounding situation using the mobile device camera 8.

As illustrated in FIG. 4A, the marker 4 may be attached to a work target object such as the conveyor 1 or the cart 3. Examples of the marker 4 include an augmented reality (AR) marker, a two-dimensional code, a barcode, or the like, but are not limited to these. In this case, the mobile device 6 may execute processing for detecting the marker 4 from the real image generated by the mobile device camera 8. Then, the mobile device 6 may stop at a position where the marker 4 is detected in the real image generated by the mobile device camera 8 and image the marker 4 at that position. The mobile device control unit 15 may execute the processing for detecting the marker 4 from the real image. Then, the mobile device control unit 15 may stop the mobile device 6 at the position where the marker 4 is detected in the real image and cause the mobile device 6 to image the marker 4 at that position.

The mobile device control unit 15 analyzes the real image generated by the mobile device camera 8 by the calibration and acquires three-dimensional information of an object positioned around the mobile device 6. The three-dimensional information includes a shape, a size, and position information of the object.

Acquisition of the three-dimensional information indicating the shape and the size of the object is achieved by various means. For example, in a case where the marker 4 is attached to the work target object as in the example in FIGS. 4A and 4B, the mobile device control unit 15 may acquire the three-dimensional information of each object using the marker 4. For example, in a case where the marker 4 is an AR marker, the mobile device control unit 15 may acquire three-dimensional information of an object registered in association with each AR marker, by reading the AR marker attached to each object. The three-dimensional information may be a three-dimensional image in which each object is designed or may be text data or the like indicating a shape and a size of each object.

In addition, in a case where the marker 4 is a two-dimensional code, the mobile device control unit 15 may acquire three-dimensional information of an object indicated by each two-dimensional code, by reading the two-dimensional code attached to each object. The three-dimensional information may be text data or the like indicating a shape and a size of each object.

In addition, the mobile device control unit 15 may detect the object from the real image, by using an image analysis technology such as an object detection technology. Then, the mobile device control unit 15 may estimate the three-dimensional information of the object from a two-dimensional real image, for example, using a deep learning based estimation model. For example, the mobile device control unit 15 can estimate the three-dimensional information of the object using the estimation model such as Pix2Vox, Mesh R-CNN, or DETR3D.

Acquisition of the position information is achieved by various means. For example, a calculation model may be generated in advance that calculates coordinates of a target object in a three-dimensional space, from coordinates and a direction of the mobile device camera 8 in the three-dimensional space and a position (coordinates) and a size of the target object in the real image generated by the mobile device camera 8. Then, the mobile device control unit 15 may acquire the position information of the object around the mobile device 6, the marker 4, or the like, for example, by using this calculation model. The calculation model may use a size of the target object, to calculate depth information (distance from mobile device camera 8) of the object. The size of the target object in the real image depends on the distance between the mobile device camera 8 and the target object. In a case where the size of the target object is fixed such as the marker 4 and there is no individual difference, the distance between the mobile device camera 8 and the target object can be estimated, based on the size of the target object in the real image. The mobile device control unit 15 may use other information such as an internal parameter (focal distance, zoom magnification, or the like) of the mobile device camera 8, to calculate the position information. In a case where the mobile device camera 8 has the function for generating the depth information of the object imaged in the real image, the mobile device control unit 15 may specify the distance between the mobile device camera 8 and the target object, using the depth information.

The mobile device control unit 15 can execute the calibration every time the surrounding situation of the mobile device 6 changes, for example, every time a new cart 3 is arranged around the mobile device 6. The mobile device control unit 15 may execute the calibration in response to an input from the user. In addition, the mobile device control unit 15 may execute the calibration, in response to detection of a new cart 3 at a predetermined position using any sensor.

Returning to FIG. 7, the virtual space control unit 16 manages the virtual space that reproduces the real space. Specifically, the virtual space control unit 16 generates the virtual space that reproduces the real space and updates the virtual space in response to a change in the real space. The virtual space control unit 16 can generate the virtual space, for example, using a digital twin technology. For example, a technology such as gazebo or Rviz can be applied to the virtual space control unit 16.

The virtual space control unit 16 can arrange the objects (conveyor 1, cart 3, or the like) around the mobile device 6 acquired by the calibration at predetermined positions in the virtual space, based on three-dimensional information of the objects. In one example, the mobile device 6 is arranged in the virtual space in advance. Then, the virtual space control unit 16 can determine a position (coordinates) of the surrounding object in the virtual space, based on a positional relationship between the mobile device 6 and the surrounding object specified by the calibration and a position (coordinates) of the mobile device 6 in the virtual space.

The virtual space control unit 16 can determine a position and a direction of the virtual camera arranged in the virtual space. The virtual space control unit 16 determines the position (coordinates) of the virtual camera based on the three-dimensional information of the cart 3. For example, a calculation model that calculates the position of the virtual camera from the three-dimensional information of the cart 3 is generated, in advance. The virtual space control unit 16 can determine the position of the virtual camera, using the three-dimensional information of the cart 3 and the calculation model. In one example, the virtual space control unit 16 determines a position where it is possible to image the floor of the cart 3 from the upper side of the cart 3 toward the lower side of the cart 3, as in the virtual image displayed in the second area B in FIG. 5, as the position of the virtual camera. In this case, the virtual space control unit 16 determines a direction in which it is possible to image the floor of the cart 3 from the upper side of the cart 3 to the lower side of the cart 3, as the direction of the virtual camera. For example, the virtual space control unit 16 may determine a position vertically above the marker 4 and away from the marker 4 by a predetermined distance, as the position of the virtual camera. Then, the virtual space control unit 16 may determine a vertically downward direction as the direction of the virtual camera. The direction of the virtual camera may be fixed to the vertically downward direction.

The virtual space control unit 16 can determine the predetermined distance based on a height of the cart 3. For example, the virtual space control unit 16 may determine the height of the cart 3 as the predetermined distance. In addition, the virtual space control unit 16 may determine a value obtained by adding a predetermined correction value to the height of the cart 3 as the predetermined distance. The virtual space control unit 16 can determine the position and the direction of the virtual camera every time the calibration is executed.

The first acquisition unit 11 acquires the real image generated by imaging the real space. Specifically, the first acquisition unit 11 acquires the real image generated by imaging the real space by the mobile device camera 8.

In the object moving processing for moving the object designated by the user to the position designated by the user, the mobile device control unit 15 controls the mobile device 6 and causes the mobile device camera 8 to image an area where the object to be moved is positioned. In the real image imaged in this way, the object to be moved is imaged. In this example embodiment, the mobile device control unit 15 controls the mobile device 6 and causes the mobile device camera 8 to image the conveyor 1. In the real image imaged in this way, the object to be moved positioned on the conveyor 1 is imaged. A position of the conveyor 1 is specified by the calibration.

The “acquisition” includes at least one of an own device obtaining data or information stored in another device or a storage medium (active acquisition) and an own device receiving an input of data or information output from another device (passive acquisition). Examples of the active acquisition include making a request or the like to another device and receiving a reply to the request, accessing another device or a storage medium for reading, and the like. Examples of the passive acquisition include receiving distributed (alternatively, transmitted, push-notified, or the like) information, and the like. Furthermore, “acquisition” may be selecting and acquiring from received data or information, or selecting and receiving distributed data or information.

The second acquisition unit 12 acquires the virtual image generated by imaging the virtual space that reproduces the real space. Specifically, the second acquisition unit 12 acquires the virtual image generated by imaging the virtual space by the virtual camera. The position and the direction of the virtual camera are in a state of imaging a moving destination area of the object to be moved. In the virtual image generated by such a virtual camera, the moving destination area is imaged. In this example embodiment, a moving destination of the object to be moved is the cart 3. Then, the position and the direction of the virtual camera are in a state where it is possible to image the floor of the cart 3 from the upper side of the cart 3 to the lower side of the cart 3. In the virtual image generated by such a virtual camera, the floor or the like of the cart 3 observed from the upper side of the cart 3 to the lower side of the cart 3 is imaged.

The display control unit 13 displays the real image acquired by the first acquisition unit 11 and the virtual image acquired by the second acquisition unit 12 on the UI screen (operation screen). The UI screen is displayed on the display 50. FIG. 5 illustrates an example of the UI screen. The illustrated UI screen displays the real image generated by imaging the real space, in the first area A. The UI screen displays the virtual image generated by imaging the virtual space that reproduces the real space, in the second area B. Since details of the UI screen are as described above, description here is omitted.

In the example in FIG. 5, the display control unit 13 displays the real image and the virtual image on the screen at the same time. However, the display control unit 13 may display one of the real image and the virtual image first on the screen, and then, display the other one on the screen. Although the first area A and the second area B are arranged side by side in the example in FIG. 5, a layout of the first area A and the second area B is not limited to this. For example, the first area A and the second area B may be vertically arranged or may have another layout.

The reception unit 14 receives a predetermined instruction, by an operation on both of the real image and the virtual image displayed on the UI screen.

For example, the reception unit 14 can receive an operation for designating a certain position in the real image from the user. By this operation, an object displayed at the designated position in the real image may be designated as the object to be processed. By this operation, for example, a position in the real space displayed at the designated position in the real image may be designated as a position to be processed.

The reception unit 14 can receive an operation for designating a certain position in the virtual image from the user. By this operation, an object displayed at the designated position in the virtual image may be designated as the object to be processed. By this operation, for example, a position in the real space related to the designated position in the virtual image may be designated as the position to be processed.

In this example embodiment, the reception unit 14 receives an operation for designating the object to be moved with respect to the real image. The reception unit 14 receives an operation for designating a position where the object to be moved is placed, with respect to the virtual image. Then, the reception unit 14 receives an instruction to move the designated object to the designated position.

For example, the reception unit 14 receives a predetermined instruction, by the operation on both of the real image and the virtual image displayed on the UI screen as illustrated in FIG. 5. As in the example in FIG. 5, the reception unit 14 can receive the predetermined instruction, by an operation on both of the real image and the virtual image generated by imaging positions different from each other.

These operations by the user are performed via the input device 55. Examples of the input device 55 include, but are not limited to a touch panel, a mouse, a keyboard, a physical button, a joystick, or the like.

The mobile device control unit 15 controls the mobile device 6, in accordance with the user’s instruction received by the reception unit 14. Specifically, the mobile device control unit 15 inputs an instruction signal for moving the object designated by the user to the position designated by the user, to the mobile device 6. The mobile device 6 grasps the object designated by the user, moves the object to the position designated by the user, and places the object at that position, in accordance with the instruction signal.

The instruction signal may include position information indicating the position to be processed in a three-dimensional coordinate system (world coordinate system) used to control the mobile device 6. The position to be processed includes a position of the object to be moved designated by the user and a position of the moving destination of the object designated by the user.

For example, the mobile device control unit 15 can specify coordinates of the object to be moved in the world coordinate system, as follows. First, the mobile device control unit 15 acquires position information of the mobile device camera 8 in the world coordinate system, at a timing at which the real image is generated. At this time, the mobile device control unit 15 acquires information indicating a direction and an angle of view of the mobile device camera 8, as the world coordinate system. Then, the mobile device control unit 15 generates information indicating which position in the world coordinate system each pixel of the real image corresponds to, that is, position information in a local coordinate applied to the real image, using these pieces of information. Then, the mobile device control unit 15 specifies the coordinates of the object in the world coordinate system, by converting the generated position information in the local coordinate according to a predetermined rule. At this time, the mobile device control unit 15 may use the depth information generated by the mobile device camera 8.

For example, the mobile device control unit 15 can specify coordinates of the position of the moving destination designated by the user in the world coordinate system, as follows. The mobile device control unit 15 specifies the position designated by the user in the virtual image (for example, specific position in floor of cart 3), as coordinates in the virtual space. In a case where a coordinate system in the virtual space and the world coordinate system coincide, the mobile device control unit 15 can set the specified coordinates in the virtual space as the coordinates of the position of the moving destination designated by the user in the world coordinate system. On the other hand, in a case where the coordinate system in the virtual space and the world coordinate system do not coincide, a conversion rule for performing coordinate conversion between both coordinate systems is generated in advance. The mobile device control unit 15 converts the specified coordinates in the virtual space into the coordinates in the world coordinate system, using the conversion rule.

Next, an example of a flow of processing of the information processing device 10 will be described with reference to the flowchart in FIG. 2.

The flowchart in FIG. 2 illustrates an example of a flow of the object moving processing for moving the object designated by the user to the position designated by the user. Before the flow in FIG. 2 is executed, the information processing device 10 executes the calibration. Then, the information processing device 10 generates the virtual space that reproduces the real space, based on the three-dimensional information of the object positioned around the mobile device 6 acquired by the calibration.

In S10, the information processing device 10 acquires the real image generated by imaging the real space. Specifically, the information processing device 10 controls the mobile device 6 and causes the mobile device camera 8 to image the conveyor 1. The position of the conveyor 1 is specified by the calibration. Then, the information processing device 10 acquires the real image obtained by imaging the conveyor 1 by the mobile device camera 8.

In S11, the information processing device 10 acquires the virtual image generated by imaging the virtual space that reproduces the real space. Specifically, the information processing device 10 acquires the virtual image obtained by imaging the cart 3 by the virtual camera.

In S12, the information processing device 10 displays the real image acquired in S10 and the virtual image acquired in S11 on the UI screen. The information processing device 10 displays, for example, the UI screen as illustrated in FIG. 5, on the display 50. In the example in FIG. 5, the real image is displayed in the first area A, and the virtual image is displayed in the second area B.

In S13, the information processing device 10 receives the predetermined instruction, by the operation on both of the real image and the virtual image displayed on the UI screen. Specifically, the information processing device 10 receives the operation for designating the object to be moved (package 2), for the real image displayed in the first area A. The information processing device 10 receives the operation for designating the position where the object to be moved is placed, for the virtual image displayed in the second area B. Then, the information processing device 10 receives the instruction to move the object to be moved designated by the operation on the real image to the position designated by the operation on the virtual image. The information processing device 10 controls the mobile device 6 in accordance with the instruction from the user and moves the designated object to be moved to the designated position.

A processing order of S10 and S11 is not limited to the illustrated example. S10 and S11 may be performed in parallel, S11 may be performed after S10, or S10 may be performed after S11.

Other configurations of the information processing device 10 of the second example embodiment can be similar to the configurations of the information processing device 10 of the first example embodiment.

### Operation and Effect

According to the information processing device 10 of the second example embodiment, operations and effects similar to those of the information processing device 10 of the first example embodiment can be achieved.

The information processing device 10 of this example embodiment uses the user interface of the information processing device 10 described in the first example embodiment in a scene where the mobile device that moves the package is operated. In a case where the package is moved, the operation for designating the object to be moved and the operation for designating the position where the object to be moved is placed (moving destination) are required. In a case where a position where the object to be moved exists and the moving destination of the object to be moved are away from each other, it is not possible to image these positions within a single image. In this case, a plurality of images obtained by imaging positions different from each other is required. As described in the first example embodiment, in a case where a plurality of cameras generates the plurality of images, a cost burden required for preparing the cameras increases. A work load required for installation of a camera, maintenance of a camera, or the like increases.

Moreover, in a case where an image obtained by imaging the cart 3 as illustrated in FIG. 5 is required, a method for installing the camera in each cart 3 is considered. In a case of this method, it is necessary to prepare the cameras as many as the carts 3. In a case where scales of a facility and a work are large, the number of carts 3 to be used increases. In a case where the cameras for a large number of carts 3 are prepared, the camera is installed in each of a large number of carts 3, and the cameras are maintained, a cost burden and a work load increase.

As illustrated in FIG. 5, the information processing device 10 according to this example embodiment does not use the real image as the image obtained by imaging the cart 3. The information processing device 10 uses the virtual image obtained by imaging the cart 3 in the virtual space, instead of the real image. According to such an information processing device 10, it is not necessary to install the camera in each cart 3. As a result, problems of the cost burden and the work load can be reduced.

There is a need to check a state of the package 2 in the real image, before causing the mobile device 6 to move the package 2. For example, there are packages 2 that need to be handled carefully, such as a deformed package 2 or a deteriorated package 2. It is not preferable to move such a package 2 by the mobile device 6, and for example, it is preferable to manually and carefully move such a package 2. In addition, a case is considered where the moving destination or an arrangement position is made different depending on the state of the package 2. In order to appropriately perform such assessment/determination, there is a need to check the state of the package 2 in the real image before moving the package 2 by the mobile device 6. Therefore, the information processing device 10 presents the real image obtained by imaging the object to be moved by the mobile device camera 8 and receives the operation for designating the object to be moved via the real image. According to such an information processing device 10, it is possible to provide a user interface that meets the needs.

As illustrated in FIG. 5, the information processing device 10 can display the real image and the virtual image on the UI screen at the same time. The user can grasp the state of the package 2 and the state of the moving destination area at the same time, via the UI screen. In a case where the real image and the virtual image are displayed on the UI screen at the same time, it is possible to designate the object to be moved and to designate the position where the object is placed, by an operation such as drag and drop.

### Third Example Embodiment

### Outline

An information processing device 10 of the third example embodiment has the configuration similar to that of the second example embodiment. That is, the information processing device 10 is used in a scene where a mobile device that moves a package is operated. Then, the information processing device 10 displays a UI screen including a real image and a virtual image, receives an operation for designating an object to be moved on the real image, and receives an operation for designating a position where the object to be moved is placed on the virtual image.

In a case of this configuration, although a user checks a state of a moving destination area of the object to be moved (for example, state of cart 3) in the virtual image, there is a need to check the state in the real image, at a predetermined timing such as after the object is placed. Then, the information processing device 10 controls a mobile device 6 at the predetermined timing and causes a mobile device camera 8 to image the cart 3. Then, the information processing device 10 displays the real image obtained by imaging the cart 3 by the mobile device camera 8 on the UI screen. With this configuration of the information processing device 10, it is possible to respond to the need to check the state of the moving destination area (for example: state of cart 3) in the real image at the predetermined timing, without increasing the number of cameras.

By the way, the information processing device 10 can switch “a virtual image obtained by imaging the moving destination area of the object to be moved” displayed on the UI screen to “a real image obtained by imaging the moving destination area of the object to be moved”, at the predetermined timing. In a case where a position of the virtual camera that images the virtual image immediately before the switching and a position of the mobile device camera 8 that images the real image immediately after the switching are different, viewpoints or the like of the virtual image and the real image before and after the switching are different, and a difference in displayed information increases. As a result, the user feels a feeling of strangeness in this image switching, and there is a possibility that it is not possible to instantly grasp information before and after the switching.

Therefore, the information processing device 10 positions the mobile device camera 8 at the same position as the virtual camera and causes the mobile device camera 8 to image the moving destination area of the object to be moved from that position. Then, the information processing device 10 switches “a virtual image obtained by imaging the moving destination area of the object to be moved by the virtual camera” displayed on the UI screen to “a real image obtained by imaging the moving destination area of the object to be moved by the mobile device camera 8 at the same position as the virtual camera”. According to such an information processing device 10, it is possible to suppress inconveniences caused by the image switching. Hereinafter, details will be described.

### Overview

Since the overview is similar to that of the second example embodiment, description here is omitted.

### Hardware Configuration

Since the hardware configuration is similar to that of the second example embodiment, description here is omitted.

### Functional Configuration

Next, a functional configuration of the information processing device 10 will be described in detail. FIG. 7 is an example of a functional block diagram of the information processing device 10. As illustrated, the information processing device 10 includes a first acquisition unit 11, a second acquisition unit 12, a display control unit 13, a reception unit 14, a mobile device control unit 15, and a virtual space control unit 16.

The second acquisition unit 12 acquires a virtual image generated by imaging the moving destination area by a virtual camera positioned at a first position. The display control unit 13 displays the virtual image generated by imaging the moving destination area by the virtual camera positioned at the first position on the UI screen. The reception unit 14 receives the operation for designating the position where the object to be moved is placed on such a virtual image. The first position is an arrangement position of the virtual camera determined by the virtual space control unit 16. These processing can be similar to those in the first and second example embodiments.

The mobile device control unit 15 controls an operation of the mobile device 6 at a timing at which a predetermined switching condition is satisfied, causes the mobile device camera 8 to position at the first position to perform imaging in the same direction as the virtual camera. The first acquisition unit 11 acquires a real image generated by imaging the moving destination area by the mobile device camera 8 positioned at the first position. The display control unit 13 switches the image displayed on the UI screen, from “the virtual image generated by imaging the moving destination area by the virtual camera positioned at the first position” to “the real image generated by imaging the moving destination area by the mobile device camera 8 positioned at the first position”.

The “switching condition” is, for example, that the mobile device 6 places the object to be moved in the moving destination area. The information processing device 10 may receive information indicating that the object to be moved has been placed in the moving destination area (work completion notification), from the mobile device 6. In addition, the information processing device 10 may analyze the real image imaged by the mobile device camera 8 and detect that the object to be moved has been placed in the moving destination area.

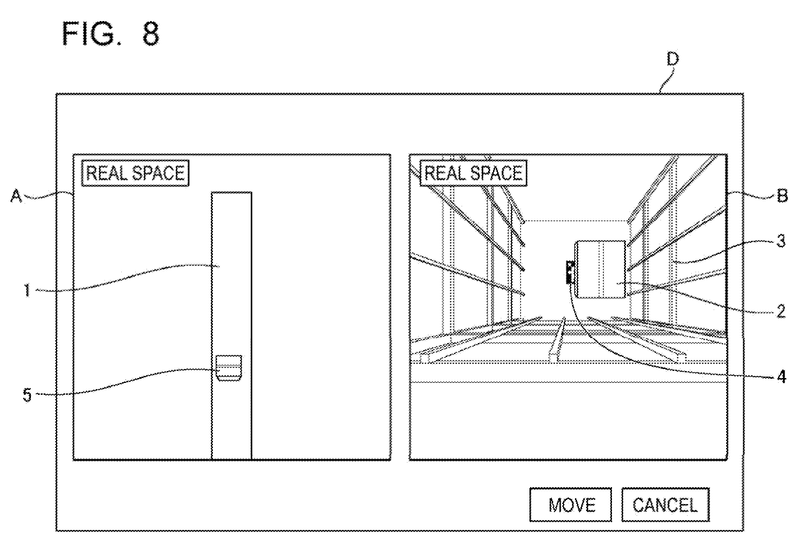

Here, an example of the image switching processing will be described with reference to FIGS. 5 and 8.

First, the UI screen in FIG. 5 is displayed. The UI screen in FIG. 5 displays a real image generated by imaging a real space, in a first area A. The UI screen displays the virtual image generated by imaging the virtual space that reproduces the real space, in the second area B. The user designates the object to be moved, designates the position where the object to be moved is placed, and instructs to place the designated object at the designated position, for example, via such a UI screen.

In response to the instruction, the mobile device 6 performs an operation for placing the designated object at the designated position. A position and a direction of the mobile device camera 8 are changed in response to this operation. Therefore, while the mobile device 6 performs this operation, a viewpoint and content of the real image displayed in the first area A change.

While the mobile device 6 performs this operation, content of the virtual image displayed in the second area B does not need to change. As another example, the virtual space control unit 16 may detect a change in a state in the real space via various sensors in real time and reflect the change in the virtual space in real time. In this case, the content of the virtual image displayed in the second area B may change according to a change in the state in the virtual space. For example, a status of the operation by the mobile device 6 may be displayed in the virtual image displayed in the second area B. For example, an arm of the mobile device 6 or a package 2 may be imaged in the virtual image displayed in the second area B, according to a progress of the operation by the mobile device 6. It is assumed that a position and a direction of the virtual camera do not change.

Then, in a case of detecting that the mobile device 6 has placed the object to be moved in the moving destination area (that switching condition is satisfied), the mobile device control unit 15 controls the operation of the mobile device 6 and positions the mobile device camera 8 at the first position. After the mobile device camera 8 is positioned at the first position, the display control unit 13 switches the image in the second area B. That is, the display control unit 13 switches “a virtual image generated by imaging the cart 3 by the virtual camera positioned at the first position” to “a real image generated by imaging the cart 3 by the mobile device camera 8 positioned at the first position”. For example, the image in the second area B is switched from the state in FIG. 5 to the state in FIG. 8. In the example in FIG. 5, although the package 2 is not imaged in the virtual image displayed in the second area B immediately before the switching, in a case where a change in a real world is reflected on the virtual space in real time, the package 2 is imaged in the virtual image displayed in the second area B immediately before the switching.

By the way, before the switching, the real image generated by the mobile device camera 8 is displayed in the first area A. As in the example in FIG. 8, in a case where the real image generated by the mobile device camera 8 is displayed in the second area B after the switching, the same real image generated by the mobile device camera 8 is displayed in both of the first area A and the second area B. In order to eliminate the waste, the display control unit 13 may display another image in the first area A, while displaying the real image generated by the mobile device camera 8 in the second area B.

For example, in a case where there are an overhead camera and the like that image a work site from a ceiling of a facility or the like, the display control unit 13 may acquire an image generated by these cameras and display the image in the first area A. In the example in FIG. 8, in the first area A, the image generated by the overhead camera that images the work site from the ceiling of the facility or the like is displayed.

As a modification, the display control unit 13 may display an image prepared in advance in the first area A. The image prepared in advance may be an image obtained by imaging a conveyor 1 by any camera such as the mobile device camera 8 or may be an image indicating guide information such as “please check an image on the right side” using a text or the like. The display control unit 13 may make a state where nothing is displayed, without displaying the image in the first area A.

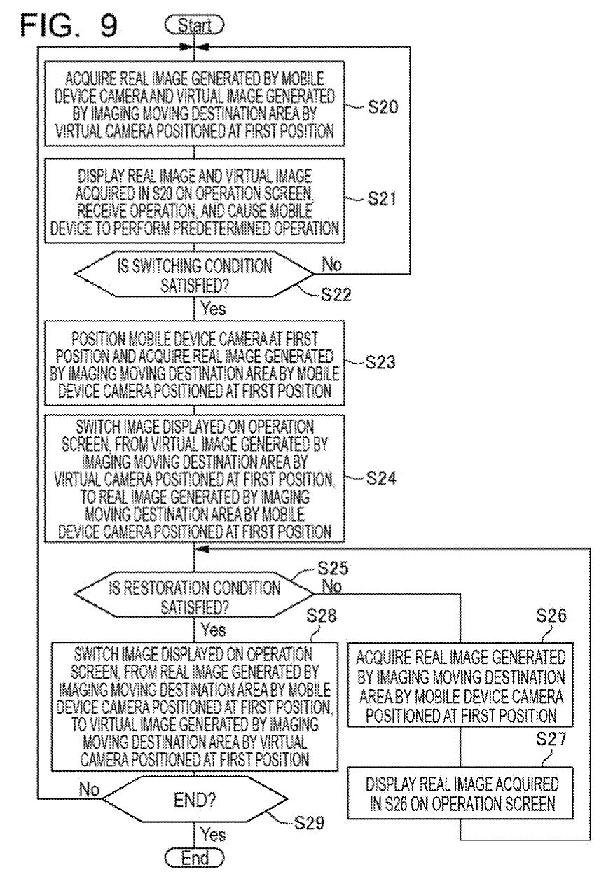

Next, an example of a flow of processing of the information processing device 10 will be described with reference to the flowchart in FIG. 9.

The flowchart in FIG. 9 illustrates an example of a flow of object moving processing for moving the object designated by the user to the position designated by the user. Before the flow in FIG. 9 is executed, the information processing device 10 executes the calibration described in the second example embodiment. Then, the information processing device 10 generates the virtual space that reproduces the real space, based on the three-dimensional information of the object positioned around the mobile device 6 acquired by the calibration.

The information processing device 10 acquires the real image generated by the mobile device camera 8 and the virtual image generated by imaging the moving destination area by the virtual camera positioned at the first position (S20).

Specifically, the information processing device 10 controls the mobile device 6 and causes the mobile device camera 8 to image the conveyor 1. Then, the information processing device 10 acquires the real image obtained by imaging the conveyor 1 by the mobile device camera 8. The information processing device 10 acquires the virtual image obtained by imaging the cart 3 by the virtual camera.

Next, the information processing device 10 executes processing in S21. First, as illustrated in FIG. 5, the information processing device 10 displays the real image and the virtual image acquired in S20 on the UI screen (operation screen). In the example in FIG. 5, the real image is displayed in the first area A, and the virtual image is displayed in the second area B.

In S21, the information processing device 10 receives the operation from the user via the UI screen. Specifically, the information processing device 10 receives the operation for designating the object to be moved (package 2), for the real image displayed in the first area A. The information processing device 10 receives the operation for designating the position where the object to be moved is placed, for the virtual image displayed in the second area B. Then, the information processing device 10 receives the instruction to move the object to be moved designated by the operation on the real image to the position designated by the operation on the virtual image.

In S21, the information processing device 10 controls the mobile device 6 in accordance with the instruction from the user and moves the designated object to be moved to the designated position.

Next, in S22, the information processing device 10 determines whether the switching condition is satisfied. The switching condition is, for example, that the mobile device 6 places the designated object to be moved at the designated position. In a case where the switching condition is not satisfied (No in S22), the information processing device 10 continues to perform control for acquiring the real image and the virtual image, displaying the real image in the first area A, and displaying the virtual image in the second area B.

In a case where the switching condition is satisfied (Yes in S22), the information processing device 10 controls the mobile device 6 and positions the mobile device camera 8 at the first position. The first position is a position where the virtual camera exists. Then, the information processing device 10 acquires the real image generated by imaging the moving destination area by the mobile device camera 8 positioned at the first position (S23).

Next, the information processing device 10 executes processing in S24. In S24, the information processing device 10 switches the image displayed in the second area B on the UI screen. Specifically, the information processing device 10 switches “the virtual image generated by imaging the cart 3 by the virtual camera positioned at the first position” to “the real image generated by imaging the cart 3 by the mobile device camera 8 positioned at the first position”. As a result, the display on the UI screen is, for example, as illustrated in FIG. 8. In an example, the information processing device 10 can switch the image displayed in the first area A, in response to the switching of the image in the second area B. In the example in FIG. 8, the image displayed in the first area A is the image (real image) generated by the overhead camera that images the work site from the ceiling of the facility or the like.

Thereafter, the information processing device 10 determines whether a restoration condition is satisfied (S25). The restoration condition is a condition for restoring the display of the UI screen to a state before the switching. The restoration condition is, for example, reception of a restoration instruction from the user. After the user completes checking the situation based on the real image obtained by imaging the cart 3, the user can input the restoration instruction via an input device 55.

In a case where the restoration condition is not satisfied (No in S25), the information processing device 10 acquires the real image generated by imaging the cart 3 by the mobile device camera 8 positioned at the first position (S26) and continues to perform the control for displaying the real image in the second area B of the UI screen (S27).

On the other hand, in a case where the restoration condition is satisfied (Yes in S25), the information processing device 10 returns the display on the UI screen to a state before the switching (S28). Specifically, the information processing device 10 displays the real image generated by the mobile device camera 8, in the first area A of the UI screen. The information processing device 10 displays the virtual image generated by the virtual camera, in the second area B of the UI screen.

The information processing device 10 can reflect the change in the real space caused by the processing, specifically, the movement of the package 2 to the cart 3, on the virtual space. For example, the information processing device 10 can acquire three-dimensional information of the package 2 placed in the cart 3, by analyzing the real image generated by imaging the cart 3 by the mobile device camera 8. Then, the information processing device 10 can arrange the package 2 at a predetermined position in the virtual space, based on the three-dimensional information.

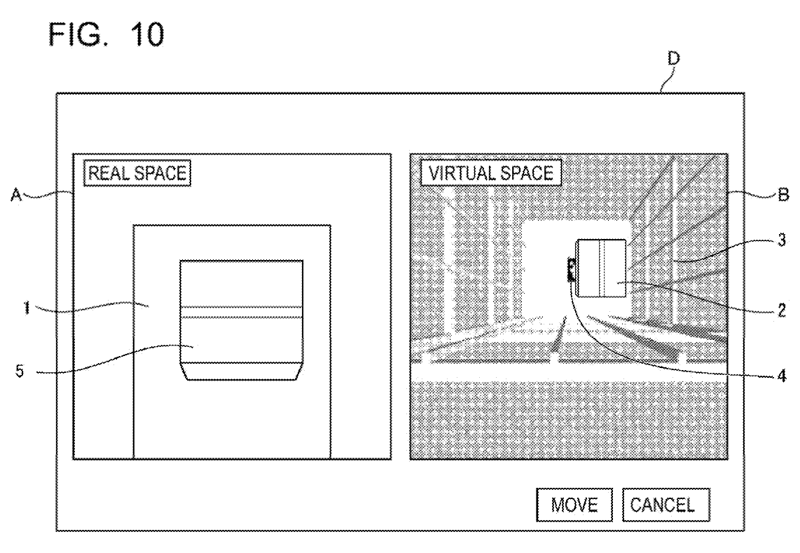

In a case where such update of the virtual space is performed, as illustrated in FIG. 10, the package 2 placed in the cart 3 is displayed in the virtual image displayed in the second area B of the UI screen after S28. In the example in FIG. 10, a new package 5 on the conveyor 1 is displayed, in the first area A. The new package 5 is a next target to be moved.

Other configurations of the information processing device 10 of the third example embodiment are similar to the configurations of the information processing devices 10 of the first and second example embodiments.

### Operation and Effect

According to the information processing device 10 of the third example embodiment, operations and effects similar to those of the information processing devices 10 of the first and second example embodiments can be achieved. The information processing device 10 controls the mobile device 6 and causes the mobile device camera 8 to image the object to be moved, and causes the mobile device camera 8 to image the moving destination area of the object. According to such an information processing device 10, information regarding a plurality of positions can be provided to the user, using the single mobile device camera 8.

The information processing device 10 switches the virtual image obtained by imaging the moving destination area to the real image obtained by imaging the moving destination area, by a characteristic method. Specifically, the information processing device 10 positions the mobile device camera 8 at the same position as the virtual camera. Then, the information processing device 10 switches “the virtual image obtained by imaging the moving destination area by the virtual camera” to “the real image obtained by imaging the moving destination area by the mobile device camera 8 at the same position as the virtual camera”. According to such an information processing device 10, it is possible to suppress inconveniences such that the user feels a feeling of strangeness, for example, by image switching.

### Examples

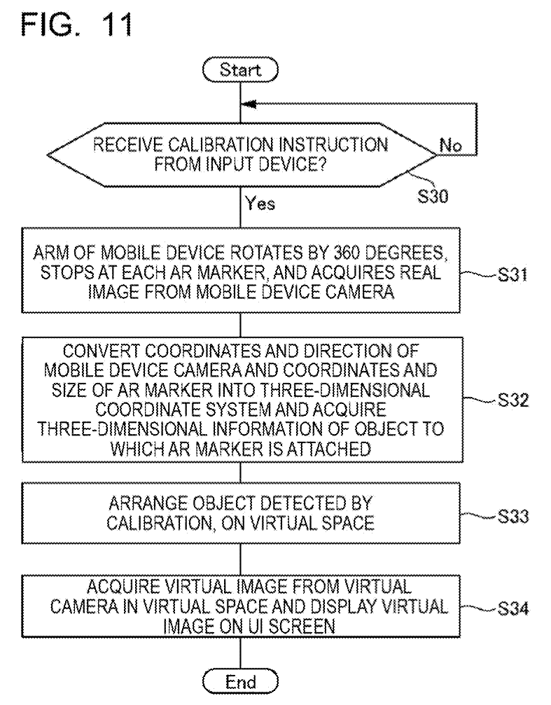

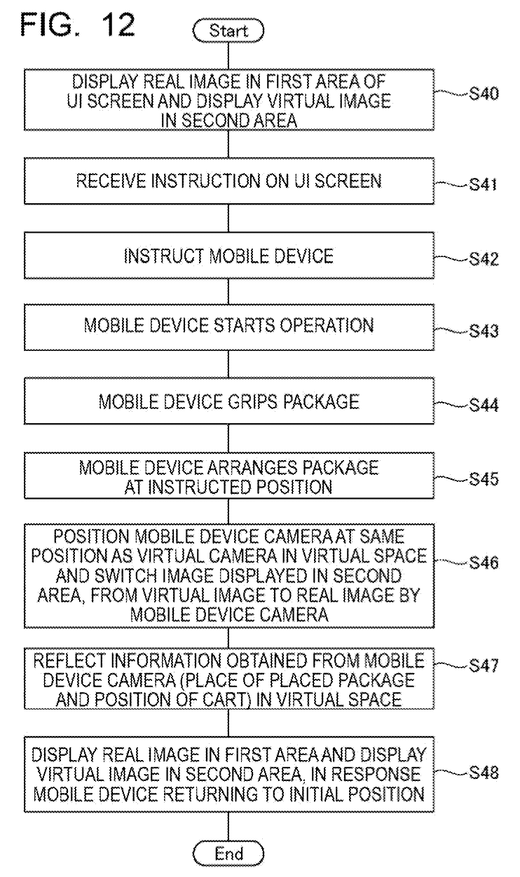

Next, examples of the processing of the information processing device 10 will be described with reference to FIGS. 11 and 12. The example of the information processing device 10 is not limited to this example.

FIG. 11 illustrates an example of a flow of processing of the calibration. Upon receiving a calibration instruction from the input device 55 (Yes in S30), the information processing device 10 rotates the arm of the mobile device 6 by 360°. Then, the information processing device 10 stops at each AR marker and acquires the real image imaged by the mobile device camera 8 (S31).

Next, the information processing device 10 acquires three-dimensional information of an object to which an AR marker is attached, by performing predetermined calculation based on coordinates and the direction of the mobile device camera 8 and coordinates, a size, or the like of the AR marker (S32).

Next, the information processing device 10 arranges the object detected in the processing (object to which AR marker is attached) in the virtual space (S33). Then, the information processing device 10 acquires the virtual image generated by the virtual camera in the virtual space and displays the virtual image on the UI screen (S34).

FIG. 12 illustrates an example of a flow of processing for moving the object. As illustrated in FIG. 5, the information processing device 10 displays the real image generated by the mobile device camera 8 in the first area A of the UI screen, and displays the virtual image obtained by imaging the cart 3 in the virtual space in the second area B (S40).

Next, the information processing device 10 receives an instruction to move the package 2 to the cart 3, on the UI screen (S41). Next, the information processing device 10 transmits the instruction to the mobile device 6 (S42).

In response to the instruction, the mobile device 6 starts the operation (S43). The mobile device 6 grips the instructed package (S44) and arranges the package at the instructed position (S45).

According to this arrangement, the information processing device 10 positions the mobile device camera 8 at the same position as the virtual camera in the virtual space. Then, the information processing device 10 switches the image displayed in the second area B of the UI screen, from the virtual image so far, to the real image generated by the mobile device camera 8 (S46). The real image generated by the mobile device camera 8 is the real image obtained by imaging the cart 3 by the mobile device camera 8. Next, the information processing device 10 acquires information regarding the package placed in the cart 3 from the real image generated by the mobile device camera 8, and reflects the presence of the package in the virtual space (S47).

Thereafter, the information processing device 10 returns the position of the mobile device 6 to an initial position, for example, in response to an instruction input from the user (S48). The initial position is, for example, a position where the mobile device camera 8 images the conveyor 1. Then, the information processing device 10 returns the display in the first area and the second area of the UI screen to a state before the switching, for example, in response to the mobile device 6 returning to the initial position. That is, the information processing device 10 displays the real image generated by the mobile device camera 8 in the first area of the UI screen, and displays the virtual image obtained by imaging the cart 3 in the virtual space in the second area. A timing of returning the display in the first area and the second area of the UI screen to the state before the switching is not limited to this.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

In the flowcharts used in the descriptions above, a plurality of steps (processing) is described in order. However, execution orders of the steps executed in each example embodiment are not limited to the described orders. In each example embodiment, the order of the illustrated steps may be changed as long as no problem is raised in content.

Some or all of the example embodiments described above may be described as, but are not limited to, the following Supplementary Notes.
1. An information processing device including:
first acquisition means for acquiring a real image generated by imaging a real space;
second acquisition means for acquiring a virtual image generated by imaging a virtual space that reproduces the real space;
display control means for displaying the real image and the virtual image on an operation screen; and
reception means for receiving a predetermined instruction, by an operation on both of the real image and the virtual image displayed on the operation screen.
2. The information processing device according to 1, in which
the display control means
displays the real image and the virtual image on the operation screen at the same time.
3. The information processing device according to 1 or 2, in which
the reception means
receives the predetermined instruction, by the operation on both of the real image and the virtual image generated by imaging positions different from each other.
4. The information processing device according to any one of 1 to 3, in which
the reception means
receives an operation for designating an object to be moved on the real image and receives an operation for designating a position where the object to be moved is placed on the virtual image.
5. The information processing device according to 4, in which
the reception means
receives an instruction to move the object to be moved designated by the operation on the real image to the position where the object to be moved is placed designated by the operation on the virtual image, as the predetermined instruction.
6. The information processing device according to any one of 1 to 5, in whichthe
first acquisition means
acquires the real image generated by imaging the real space by a mobile device camera attached to a mobile device that moves the object to be moved, and
the second acquisition means
acquires the virtual image generated by imaging a moving destination area of a package reproduced in the virtual space by a virtual camera.
7. The information processing device according to 6, in which
the second acquisition means
acquires the virtual image generated by imaging the moving destination area by the virtual camera positioned at a first position,
the display control means
displays the virtual image generated by imaging the moving destination area by the virtual camera positioned at the first position on the operation screen,
in a case where a predetermined condition is satisfied,
the first acquisition means acquires the real image generated by imaging the moving destination area by the mobile device camera positioned at the first position, and
the display control means switches an image displayed on the operation screen, from the virtual image generated by imaging the moving destination area by the virtual camera positioned at the first position, to the real image generated by imaging the moving destination area by the mobile device camera positioned at the first position.
8. The information processing device according to 7, in which the predetermined condition is that the mobile device has placed the object to be moved in the moving destination area.
9. An information processing method performed by one or more computers, the method including:
   acquiring a real image generated by imaging a real space;
   acquiring a virtual image generated by imaging a virtual space that reproduces the real space; displaying the real image and the virtual image on an operation screen; and
   receiving a predetermined instruction, by an operation on both of the real image and the virtual image displayed on the operation screen.
10. A program for causing a computer to function as:
   first acquisition means for acquiring a real image generated by imaging a real space; second acquisition means for acquiring a virtual image generated by imaging a virtual space that reproduces the real space;
   display control means for displaying the real image and the virtual image on an operation screen; and
   reception means for receiving a predetermined instruction, by an operation on both of the real image and the virtual image displayed on the operation screen.

Some or all of Supplementary Notes 2 to 8 dependent on the information processing device of Supplementary Note 1 described above can also be dependent on the information processing method of Supplementary Note 9 and the program of Supplementary Note 10 by a dependency relationship similar to Supplementary Note 1 and Supplementary Notes 2 to 8. Furthermore, some or all of the configurations described as Supplementary Notes may be achieved in various pieces of hardware and software, various recording means for recording software, or systems without departing from the example embodiments described above.

1. An information processing apparatus comprising:
at least one memory configured to store one or more instructions; and
at least one processor configured to execute the one or more instructions to:
acquire a real image generated by imaging a real space;
acquire a virtual image generated by imaging a virtual space that reproduces the real space;
display the real image and the virtual image on an operation screen; and
receive a predetermined instruction, by an operation on both of the real image and the virtual image displayed on the operation screen.

2. The information processing apparatus according to claim 1, wherein
the at least one processor is further configured to execute the one or more instructions to
display the real image and the virtual image on the operation screen at the same time.

3. The information processing apparatus according to claim 1, wherein
the at least one processor is further configured to execute the one or more instructions to
receive the predetermined instruction, by the operation on both of the real image and the virtual image generated by imaging positions different from each other.

4. The information processing apparatus according to claim 1, wherein
the at least one processor is further configured to execute the one or more instructions to
receive an operation for designating an object to be moved on the real image and receive an operation for designating a position where the object to be moved is placed on the virtual image.

5. The information processing apparatus according to claim 4, wherein
the at least one processor is further configured to execute the one or more instructions to
receive an instruction to move the object to be moved designated by the operation on the real image to the position where the object to be moved is placed designated by the operation on the virtual image, as the predetermined instruction.

6. The information processing apparatus according to claim 1, wherein
the at least one processor is further configured to execute the one or more instructions to
acquire the real image generated by imaging the real space by a mobile device camera attached to a mobile device that moves the object to be moved, and
acquire the virtual image generated by imaging a moving destination area of a package reproduced in the virtual space by a virtual camera.

7. The information processing apparatus according to claim 6, wherein
the at least one processor is further configured to execute the one or more instructions to
acquire the virtual image generated by imaging the moving destination area by the virtual camera positioned at a first position,
display the virtual image generated by imaging the moving destination area by the virtual camera positioned at the first position on the operation screen,
in a case where a predetermined condition is satisfied,
acquires the real image generated by imaging the moving destination area by the mobile device camera positioned at the first position, and
switch an image displayed on the operation screen, from the virtual image generated by imaging the moving destination area by the virtual camera positioned at the first position, to the real image generated by imaging the moving destination area by the mobile device camera positioned at the first position.

8. The information processing apparatus according to claim 7, wherein the predetermined condition is that the mobile device has placed the object to be moved in the moving destination area.

9. An information processing method performed by one or more computers, the method comprising:
acquiring a real image generated by imaging a real space;
acquiring a virtual image generated by imaging a virtual space that reproduces the real space;
displaying the real image and the virtual image on an operation screen; and
receiving a predetermined instruction, by an operation on both of the real image and the virtual image displayed on the operation screen.

10. The information processing method according to claim 9, wherein
the one or more computers display the real image and the virtual image on the operation screen at the same time.

11. The information processing method according to claim 9, wherein
the one or more computers receive the predetermined instruction, by the operation on both of the real image and the virtual image generated by imaging positions different from each other.

12. The information processing method according to claim 9, wherein
the one or more computers receive an operation for designating an object to be moved on the real image and receive an operation for designating a position where the object to be moved is placed on the virtual image.

13. The information processing method according to claim 12, wherein
the one or more computers receive an instruction to move the object to be moved designated by the operation on the real image to the position where the object to be moved is placed designated by the operation on the virtual image, as the predetermined instruction.

14. The information processing method according to claim 9, wherein
the one or more computers
acquire the real image generated by imaging the real space by a mobile device camera attached to a mobile device that moves the object to be moved, and
acquire the virtual image generated by imaging a moving destination area of a package reproduced in the virtual space by a virtual camera.

15. A non-transitory computer-readable medium storing a program for causing a computer to:
acquire a real image generated by imaging a real space;
acquire a virtual image generated by imaging a virtual space that reproduces the real space;
display the real image and the virtual image on an operation screen; and
receive a predetermined instruction, by an operation on both of the real image and the virtual image displayed on the operation screen.

16. The non-transitory computer-readable medium according to claim 15, wherein
the program causes the computer to
display the real image and the virtual image on the operation screen at the same time.

17. The non-transitory computer-readable medium according to claim 15, wherein
the program causes the computer to
receive the predetermined instruction, by the operation on both of the real image and the virtual image generated by imaging positions different from each other.

18. The non-transitory computer-readable medium according to claim 15, wherein
the program causes the computer to
receive an operation for designating an object to be moved on the real image and receive an operation for designating a position where the object to be moved is placed on the virtual image.

19. The non-transitory computer-readable medium according to claim 18, wherein
the program causes the computer to
receive an instruction to move the object to be moved designated by the operation on the real image to the position where the object to be moved is placed designated by the operation on the virtual image, as the predetermined instruction.

20. The non-transitory computer-readable medium according to claim 15, wherein
the program causes the computer to
acquire the real image generated by imaging the real space by a mobile device camera attached to a mobile device that moves the object to be moved, and
acquire the virtual image generated by imaging a moving destination area of a package reproduced in the virtual space by a virtual camera.
